(19) United States
(12) Patent Application Publication
(10) Pub. No.: US 2018/0300666 A1
(43) Pub. Date: Oct. 18, 2018

(54) Expert Online Matching Marketplace

(71) Applicant: IMIO LLC UFI TIP, Chicago, IL (US)

(72) Inventor: Roopit Patel, Chicago, IL (US)

(21) Appl. No.: 16/013,763

(22) Filed: Jun. 20, 2018

Related U.S. Application Data
(63) Continuation of application No. 14/927,817, filed on Oct. 30, 2015, now abandoned.
(60) Provisional application No. 62/072,817, filed on Oct. 30, 2014.

(51) Int. Cl. G06Q 10/06; G06Q 10/10

(52) U.S. Cl. CPC G06Q 10/063112; G06Q 10/1053

(57) ABSTRACT

A platform which enables experts to be matched with others in the same domain and creates a marketplace in which particular skills can be assessed. The platform enables all aspects from searching for and matching experts with others, to the scheduling and communication with all interested parties, to the actual assessment and all subsequent reporting and analytics. Companies can use this platform to assess potential talent for specific jobs or projects. Candidates can also use the platform to identify, engage, and schedule a skills assessment for themselves, and then promote themselves to potential companies via a score and a badge.

The present invention claims priority to U.S. nonprovisional patent application no. 62/072,817, titled “Expert Matching Online Marketplace,” filed Oct. 30, 2014, which is incorporate herein by reference in its entirety.

### TECHNICAL FIELD

The present invention is in the technical field of online expert assessments. More particularly, the present invention is a platform which enables experts to be matched with others in the same domain and creates a marketplace in which particular skills can be assessed. The platform enables all aspects from searching for and matching experts with others, to the scheduling and communication with all interested parties, to the actual assessment and all subsequent reporting and analytics.

### BACKGROUND

In a rapidly changing world, finding the right talent for the right job is becoming much harder, much more competitive, and even more imperative. Companies large and small are unable to keep up with and reliably assess candidates applying for many of the latest jobs or properly evaluate different service companies that are proposing to take on significant projects for them. Additionally, talent that may not have the right resume or years of experience but have obtained significant skills from other schools or courses are being glossed over. This platform connects and makes available never before accessible experts that are still in the industry in order to evaluate this talent.

The result saves organizations valuable time and money in their processes while significantly reducing the risks and costs associated with making poor talent acquisition decisions. It also provides value to those candidates looking to enter the job market that are currently overlooked.

The present invention allows a user to identify, engage, rate, and schedule an independent, objective expert to conduct a skills assessment. The result of the assessment includes a report indicating the actual skill level of the candidate that the company may use in any personnel or project decision. The company can rate and review the expert for a continued feedback loop.

The present invention also allows a candidate to identify, engage, and schedule an independent, objective expert to conduct an interview independently of a specific job. The candidate receives a report indicating their actual skill level as well as a badge and score. The candidate can promote their badge and score to potential hiring managers as an indication of their skills. The candidate can rate and review the expert for a continued feedback loop.

### SUMMARY OF THE INVENTION

The present invention is an online skills assessment platform that allows users to identify, engage, rate and schedule a skills interview for a job candidate. The result of the interview includes a detailed report that the company can use to make any personnel or project decision.

### BRIEF DESCRIPTION OF THE DRAWINGS

FIG. 1 describes the process of a user arriving at the online expert marketplace, searching for or selecting an expert, and viewing the details about that expert;

FIG. 2 describes the process of a user communicating with an expert, selecting an available time, providing job and candidate information, and paying for the assessment;

FIG. 3 describes the process of the expert conducting the assessment, creating an evaluation report, and providing that report to the company;

FIG. 4 describes the process of a candidate arriving at the online expert marketplace, searching for or selecting an expert, and viewing the details about that expert;

FIG. 5 describes the process of a candidate communicating with an expert, selecting an available time, providing their own information, and paying for the interview;

FIG. 6 describes the process of the expert conducting the assessment, creating an evaluation report, badge, and score, and then providing that information to the candidate.

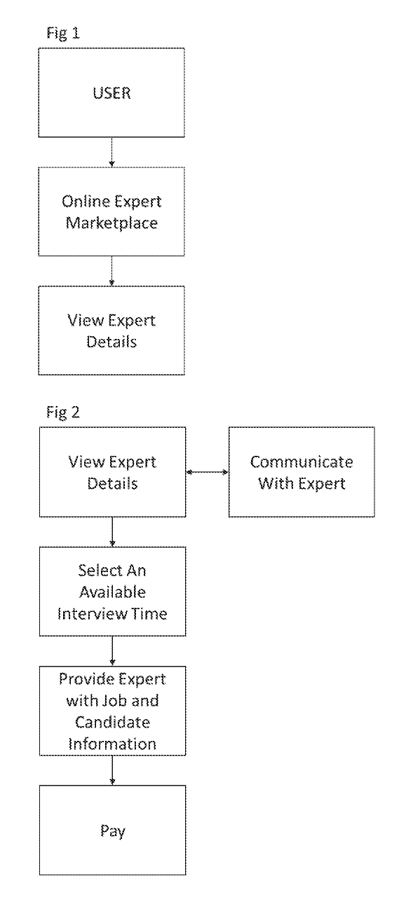

### DETAILED DESCRIPTION OF THE INVENTION

Referring now to the invention in more detail, in FIG.. 1, a user arrives at the online expert marketplace. They locate an expert by searching by key words or by selecting one or more filters. When the user conducts a search by key words, experts will be displayed based on an algorithm matching the request to the online profile (the profile found on the online expert marketplace). Users will be able to search based on skills, industries, availability, ratings, cost among other features.

Once the user has identified an appropriate expert, they view that expert's details. The expert's details contains information about that expert's prior job experience, plus any other information that the user will find valuable to ensure that the expert is appropriate to conduct an assessment.

Referring now to the invention in more detail, in FIG. 2., once a user is viewing the expert's details, the user can communicate with the expert through various electronic methods. Once the user is convinced that the expert is appropriate to conduct an assessment, the user selects the date and time desired for that assessment to take place.

The platform enables the expert to manage their availability in order to provide efficient scheduling.

Once the date and time for the interview is set, the user provides information about the job that the user is trying to hire a candidate to fill, as well as information about the candidate. The user can provide as many relevant documents as they wish through the platform as well as provide information about the candidate. Once the user has provided all of the relevant information about the job and the candidate, they continue to pay for the assessment.

The user has the option to pay for a single assessment, or to purchase bundles of assessments at a discount. If the user wishes to purchase a single assessment, they enter their payment information and complete the payment. The user, expert, and candidate are notified of the upcoming interview. If the user has previously purchased a bundle of interviews, instead of entering their payment information, they enter a coupon code to complete the transaction. After using a coupon code to complete the transaction, the user, expert, and candidate are notified of the upcoming interview.

If the user decides to purchase a bundle of interviews at a discount, after the transaction is complete, the user, expert and candidate are notified of the upcoming interview, and the user is provided a coupon code they can use in the future to schedule interviews.

If the user has scheduled all of the interviews they purchased in a bundle, the online expert marketplace notifies the user that they must purchase one or more interviews to continue.

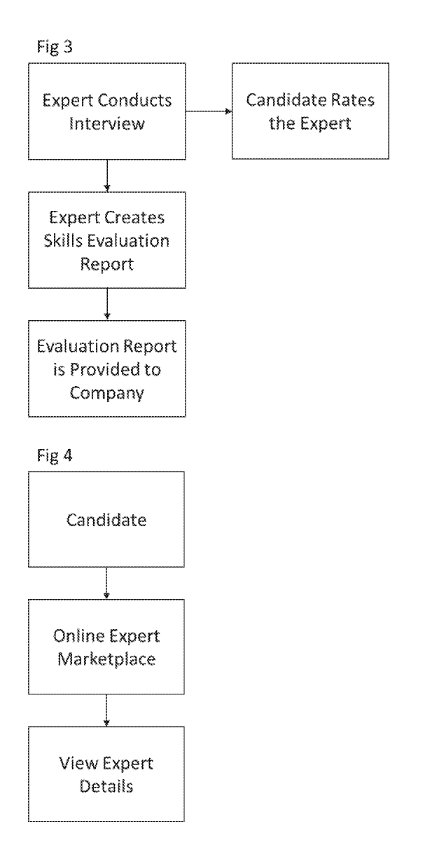

Referring to the invention in more detail, in FIG. 3, the expert coordinates with the candidate to finalize the date and time of the interview. The expert reviews, in detail, the information provided by the user about the job and the candidate.

The expert either calls the candidate via phone or uses a video conference technology to conduct the interview. The expert may record the interview. Once the interview is complete, the expert fills out a specific online form (report) indicating the relative skills of that candidate. The expert “rates” the candidate based on a number of predetermined general skill categories as well. The expert provides sends the report back to the online expert marketplace and that report is then sent to the user.

The candidate has the option of rating the quality of the interview and the expert as well. This information is not provided to the user, but is stored on the online expert marketplace for internal use and quality control.

Referring to the invention in more detail, in FIG. 4, a candidate wishing to be pre-qualified by an expert arrives at the online expert marketplace. The candidate locates an expert by searching by key words or by selecting one or more filters. When the candidate conducts a search by key words, only experts who have those specified key words within the body of their online profile (the profile found on the online expert marketplace) are displayed. When the candidate selects a filter, only experts who match the filter criteria are displayed.

Once the candidate has identified an appropriate expert, they view that expert's details. The expert's details contains information about that expert's prior job experience, plus any other information that the candidate will find valuable to ensure that the expert is appropriate to conduct an interview.

Referring now to the invention in more detail, in FIG. 5., once a candidate is viewing the expert's details, the candidate can communicate with the expert by sending that expert an email message. Once the candidate is convinced that the expert is appropriate to conduct an interview, the candidate selects the date and time desired for that interview to take place.

The schedule presented to the candidate has been predetermined and set by the expert, so the candidate is confident that the selected time will indeed be available.

Once the date and time for the interview is set, the candidate provides information about their background (job history, skills, and other information). The candidate can upload as many relevant documents as they wish as well as provide information about themselves in text fields. Once the candidate has provided (uploaded) all of the relevant information they continue to pay for the interview.

The candidate has the option to pay for a single interview. They enter their payment information and complete the payment. The user, expert, and candidate(s) are notified of the upcoming assessment.

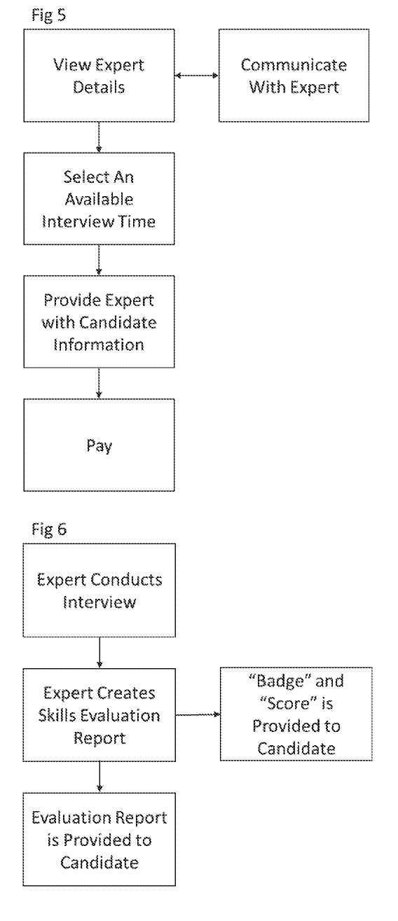

Referring to the invention in more detail, in FIG. 6, the expert coordinates with the candidate to finalize the date and time of the assessment. The expert reviews, in detail, the information provided by the candidate.

Within the platform, the expert either calls the candidate via phone or uses a video conference technology to conduct the assessment. The expert may record the assessment. Once the assessment is complete, the expert fills out a specific online form (report) indicating the relative skills of that candidate. The expert “rates” the candidate based on a number of predetermined general skill categories as well. The expert provides sends the report back to the online expert marketplace and that report is then sent to the candidate.

The candidate has the option of rating the quality of the assessment and the expert as well. This information is stored on the online expert marketplace for internal use and quality control. The candidate can use their rating to promote their skills to companies they wish to work for in the future. The candidate is also provided with an electronic badge they can use to promote their skills.

I claim:

1. A method of matching experts with interview candidates comprising the steps of:
providing a system storing information relating to a plurality of experts;
selecting an expert based on the information stored in the system;
matching the expert with an interview candidate based on the information stored in the system;
conducting an interview between the expert and the candidate.
